(19) United States
(12) Patent Application Publication
(10) Pub. No.: US 2006/0215626 A1
(43) Pub. Date: Sep. 28, 2006

(54) Apparatus to transmit OFDM symbols with aligned fragmentation threshold

(75) Inventor: Rony Ross, Tel-Aviv (IL)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/090,406

(22) Filed: Mar. 25, 2005

(51) Int. Cl. H04B 7/208

(52) U.S. Cl. 370/344

(57) ABSTRACT

In one embodiment, an apparatus comprises a transmitter to transmit a plurality of Orthogonal Frequency Division Multiplexing (OFDM) symbols with each of the OFDM symbols having a first number of bytes; and a controller, coupled to the transmitter, to determine an initial fragmentation threshold value having a second number of bytes. The controller is operable to increase the second number of bytes to generate an aligned fragmentation threshold value having an aligned number of bytes approximately equal to a multiple of the first number of bytes. The apparatus further includes a fragmentation module to fragment a data frame into a plurality of fragments in response to the aligned fragmentation threshold value.

### BACKGROUND

1. Technical Field

Embodiments of the present invention are related to the field of electronic devices, and in particular, to communication devices.

2. Description of Related Art

Network stations or devices in a Wireless Local Area Network (WLAN) may communicate with each other according to the wireless protocol provided by an Institute of Electrical and Electronic Engineers (IEEE) 802.11 standard. The IEEE 802.11 standard is defined in International Standard ISO/IEC 8802-111, “Information Technology-Telecommunications and Information Exchange Area Networks,” 1999 Edition. Extending the original IEEE 802.11 standard is an IEEE 802.11a standard (1999) in the 5 GHz U-NII bands and an IEEE 802.11g standard (1999) in the 2.4 GHz U-NII bands. An IEEE Task Group is currently working on an IEEE 802.11n standard. IEEE 802.11a and IEEE 802.11g (and in the future IEEE 802.11n) provide for network stations to operate according to different data rates using different Orthogonal Frequency Division Multiplexing (OFDM) symbols.

A transmitted frame over the wireless medium may be corrupted or lost due to various factors, such as path loss, fading and interference. While the IEEE 802.11 standard supports variable length frames, longer frames may be subject to a larger probability of error. Hence, the standard defines a process called fragmentation, which produces smaller fragments out of an original frame. Fragmentation increases reliability by increasing the probability of successful transmission of the fragments in cases where channel characteristics limit reception reliability for longer frames. When a frame is received by Medium Access Control (MAC) unit of the WLAN device with a length greater than a given fragmentation threshold, the frame is fragmented.

The number of data bits in each OFDM symbol is defined by the data rate. For example, at the data rate of 54 Mbps with IEEE 802.11a, each OFDM symbol may include 216 data bits, which is 27 bytes. Due to the fragmentation, even if there is only one data byte to be transmitted in a given symbol, the whole symbol will be used and will carry 26 unused data bytes.

### BRIEF DESCRIPTION OF THE DRAWINGS

FIG. 1 is a block diagram of a system incorporating network stations according to one embodiment of the present invention.

FIG. 2 is a functional block diagram of a network station according to one embodiment of the present invention.

FIG. 3 is a chart of one illustrative set of the data rates and number of data bits per second for the network station of FIG. 2 according to one embodiment of the present invention.

FIG. 4 is a diagram of a MSDU segmented by a fragmentation module of the network station of FIG. 2, according to one embodiment of the present invention.

FIG. 5 is a functional block diagram of a MAC and a PHY unit of the network station of FIG. 2 according to one embodiment of the present invention.

FIG. 6 is a functional block diagram of a threshold determination module of the network station of FIG. 2 according to one embodiment of the present invention.

FIG. 7 is a functional block diagram of another threshold determination module of the network station of FIG. 2 according to one embodiment of the present invention.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

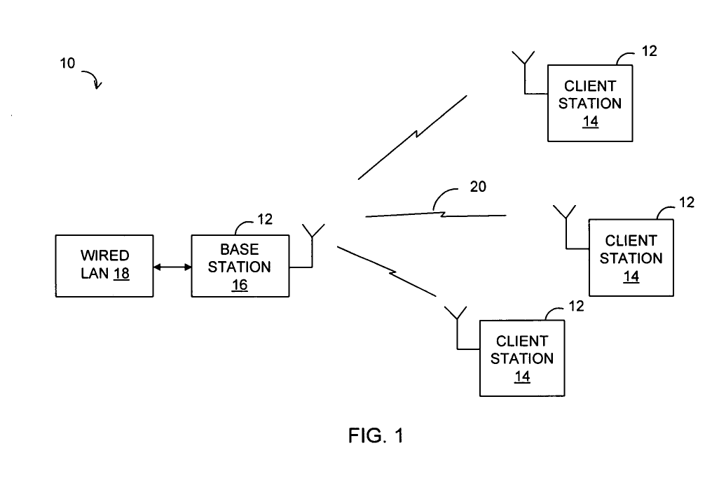

With reference to FIG. 1, a wireless local area network (WLAN) communication system 10 is illustrated. The WLAN communication system 10 is illustrative of one of a number of systems wherein at least two network stations (or WLAN devices) 12, in accordance with one embodiment of the present invention, may be implemented. In one embodiment, the network station 12 may be a client station (or user device) 14. In another embodiment, the network station 12 may be a base station 16 providing an access point. Hence, the term “network stations” or “stations” 12 shall generically refer both to the client stations 14 and the base station 16. The base station 16 may provide access to a wired network, such as a wired LAN 18, for one or more of the client stations 14. Although not shown, one or more additional base stations may also be coupled to the wired LAN 18 to provide wireless access for additional client devices. The wired LAN 18 may include, for example, one or more servers for providing client/server functions within the communications system 10. The wired LAN 18 may also include functionality for providing a connection to another network (e.g., the Internet, a wide area network, etc.). The client stations 14 may include any of a wide variety of different digital data handling devices including, for example, laptop, palmtop, and/or desktop computers; personal digital assistants (PDA); pagers; and/or others. The number of user devices that can be supported by a base station 16 may vary from system to system. Each network station 12 (base station 16 and client stations 14) may represent a combination of hardware, software and firmware that appears to other stations as a single functional and addressable unit on the network.

In the arrangement of FIG. 1, the client stations 14 are associated with the base station 16 to form an infrastructure basic service set (BSS). In another arrangement, the client stations 14 may be arranged in a peer-to-peer configuration referred to as an independent basis service set (IBSS). Although not shown, it will be appreciated that the communication system 10 may include one or more of both types of configurations, that is, the IBSS and infrastructure BSS configurations. During a communication between at least two of the network stations 12 over a wireless transmission medium 20, a first network station 12 serves as a transmitting network station (or transmitter) and at least one second network station 12 serves as a receiving network station (or receiver). The present disclosure employs various concepts and terminology of the IEEE 802.11, 802.11a, and 802.11g standards for purposes of explanation and illustration of exemplary embodiments, although it is understood that the present invention is not limited to communications according to the IEEE 802.11, the 802.11a, and 802.11g standards but instead is applicable to any communication architecture and protocol. The term “802.11” is used to refer collectively to the original IEEE 802.11 standard and all its variants and extensions, unless specifically noted otherwise.

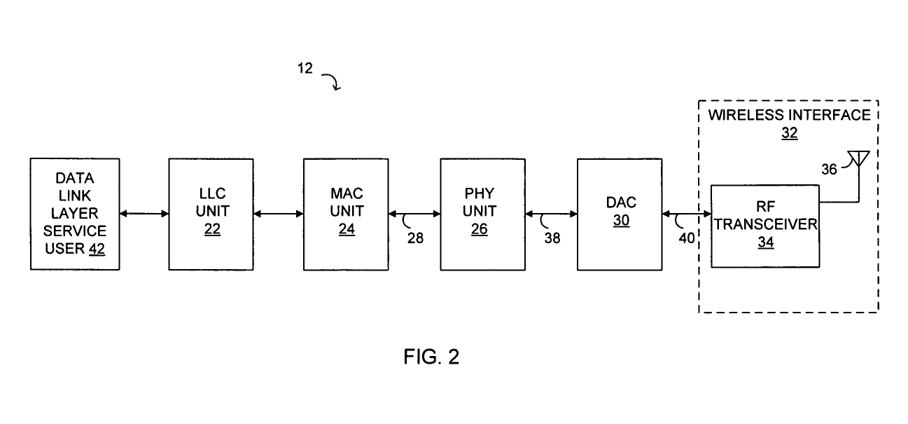

Referring to FIG. 2, an exemplary network station 12, in accordance with one embodiment of the present invention, is shown and includes a number of different functional units. In one embodiment, these functional units may conform to the layers of the Opens Systems Interconnect (OSI) model, including the data link layer, having the logical link control (LLC) sublayer and the media access control (MAC) sublayer, and the physical (PHY) layer. It should be appreciated that the individual units and blocks illustrated in FIG. 2 (and in other block diagrams herein) are functional in nature and do not necessarily represent discrete hardware elements. In addition to hardware implementations, some functional blocks (or portions thereof) may be implemented in software or firmware within a common digital processing device (e.g., a general purpose microprocessor, a digital signal processor (DSP), a reduced instruction set computer (RISC), a complex instruction set computer (CISC), a field programmable gate array (FPGA), an application specific integrated circuit (ASIC), or others). In another embodiment, individual functions also may be divided among multiple digital processing devices.

Referring to FIG. 2, the functional units of the network station 12 may include a LLC sublayer unit (“LLC unit”) 22, a MAC sublayer unit (“MAC unit”) 24, a physical medium interface unit 26 (hereinafter referred to as “PHY unit 26”) connected to the MAC unit 24 by an input/output (I/O) bus 28. The network station 12 also may include a digital to analog converter (DAC) 30 coupled to the PHY unit 26 and a wireless interface 32 coupled to the DAC 30. The wireless interface 32 may include a RF transceiver 34 and an antenna 36 coupled to the RF transceiver 34. The DAC 30 may connect to the PHY unit 26 by an I/O line 38 and may connect to the RF transceiver 34 by an interface 40. The RF transceiver 34 may include a receiver for receiving wireless RF communications from another network station and a transmitter for transmitting wireless RF communications to another network station. Wireless communications may be received and transmitted by the RF transceiver 34 via its antenna 36.

The network unit 12 may include a data link layer (DLL) service user 42 or be coupled to an external DLL service user 42. The data link service user 42 may represent any device (sometimes referred to as a host device) that uses the units 22, 24, 26, 30, and 32 (collectively referred to as the network interface unit) to communicate with another network device. The network station 12 may reside in a single system “box”, for example, comprising a host device (such as a desktop computer) with a built-in network interface unit (such as a network interface card (NIC) or adapter) or with a network interface unit integrated into the host device, e.g., integrated into a motherboard for a processor. The network station 12 also may reside in separate boxes, e.g., the network interface unit may reside in a separate network adapter that connects to a host device.

The data link layer of the network station 12, in particular the MAC unit 24, may perform data encapsulation/decapsulation, as well as media access management for transmit (TX) and receive (RX) functions. In one embodiment, the MAC unit 24 may employ a collision avoidance medium access control scheme, such as a carrier sense multiple access with collision avoidance (CSMA/CA). In one embodiment, the MAC unit 24 may be compatible with the IEEE 802.11 MAC specifications. The IEEE 802.11 MAC specifications include a mechanism to access the medium called Distributed Coordination Function (DCF). It may achieve medium sharing through the use of CSMA/CA with random backoff. The MAC unit may follow two medium access rules. First, a node is allowed to transmit only if its carrier sense mechanism determines that the medium has been idle for at least the distributed interframe space (DIFS) time. Second, the node may select a random backoff interval (contention window) after access deferral or prior to attempting to transmit again immediately after a successful transmission.

The MAC unit 24 may support other MAC functions, such as framing and Quality of Service (QoS), and may provide for reliable frame delivery through a number of different mechanisms. For example, the MAC unit 24 may provide Automatic Repeat request (ARQ) protocol support to ensure delivery for unicast transmissions. A correctly addressed frame with a valid PHY Frame Check Sequence (FCS) may cause the receiving station to transmit a positive acknowledgment (or “ACK”) response to the originating station. Transmitting stations may attempt error recovery by retransmitting frames that are known or are inferred to have failed. Failures may occur due to collisions or bad channel conditions, or lack of sufficient resources at the receiver. Transmissions are inferred to have failed for some other reason (for example, due to collisions) if there is no response, that is, no ACK. In another embodiment, transmissions are known to have failed if a “NACK” (in the case of bad channel conditions) or “FAIL” (in the case of insufficient resources) response is received. Hence, there may be the absence of an ACK, or receipt of a NACK or FAIL or other defined response to indicate the need for retransmission of a previously transmitted frame.

The PHY unit 26 may perform transmit encoding and receive decoding, modulation/demodulation, among other functions. In one embodiment, the operation of the PHY unit 26 may conform to the IEEE 802.11a or IEEE 802.11g standard and may provide a multiple data rate station using OFDM. The OFDM technique uses one wide frequency operating channel by breaking it up into several subchannels, with each having a subcarrier frequency (“subcarrier”) for transmitting data. OFDM may increase throughput by using several subcarriers in parallel and multiplexing data over the set of subchannels. OFDM, using the mathematical relationship called orthogonality, may employ subchannels that overlap but do not substantially interfere with each other. An OFDM transmitter of the PHY unit 26 may take a coded signal for each subchannel and uses an inverse Fast Fourier transform (inverse FFT) to create a composite waveform from the strength of each subchannel for transmission over a wireless medium. An OFDM receiver of the PHY unit 26 may apply an FFT to a received waveform from the wireless medium to extract the amplitude of each subcarrier. As one example, PHY unit 26, when compatible with IEEE 802.11a, may organize the frequency spectrum into a plurality of operating channels with each operating channel being 20 MHz wide. Each 20 MHz operating channel may be composed of 52 subcarriers, with 48 of these subcarriers being used to transmit data. In this example, the PHY unit 26 may use a number of different modulation schemes to achieve data rates ranging from 6 Mbps to 54 Mbps. Regardless of the data rate, a symbol rate of 250,000 symbols (OFDM symbols) per second may be used, with each OFDM symbol spanning all 48 subchannels of a given operating channel. Consequently, the number of data bits per symbol varies. If convolutional coding is used, there are a greater number of coded bits per symbol with the increased number of bits being used for forward error-correcting.

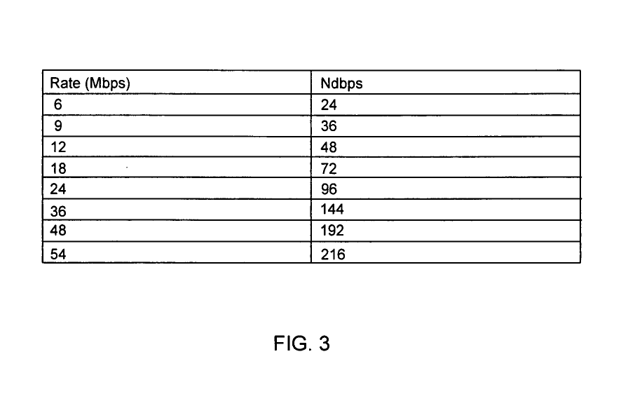

The eight PHY modes are shown in a first column (data rates in Mbps) and a second column (number of data bits per second or Ndbps for each of the rates) of FIG. 3. Currently, an IEEE Task Group is working on an IEEE 802.11n standard. This Task Group is considering various options such as: using 40 MHz channels, having more then 48 sub-carriers for data on a 20 MHz channel, increasing the symbol rate to be more then 250000 per second and so on. The PHY unit 26 may also make use of the IEEE 802.11n specifications or any other scheme utilizing OFDM symbols. In addition to the use of multiple modulation schemes, convolutional codes with variable rates may be adopted to improve the frame transmission reliability as well as the data rate. It should be appreciated that a number of different multiple data rate schemes using OFDM may be used in the network station 12.

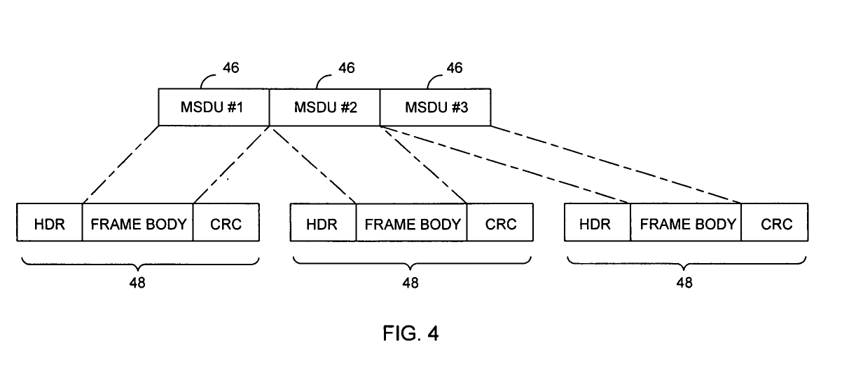

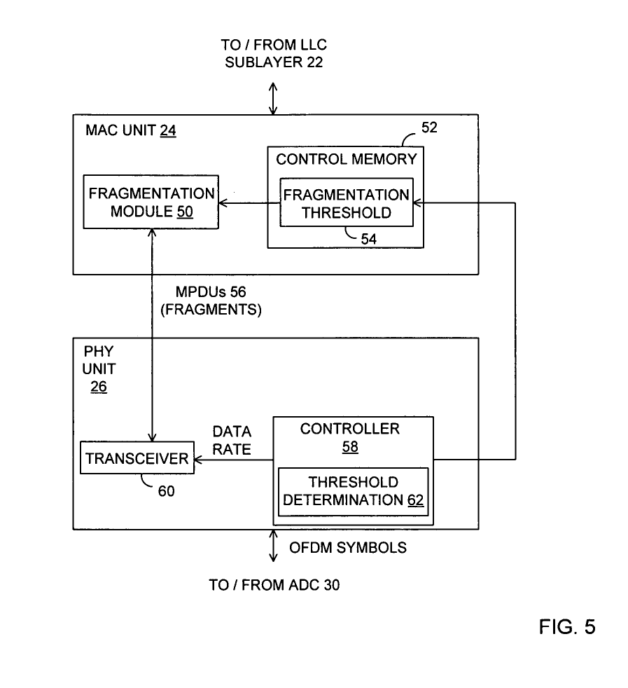

The unit of communication exchanged between nodes over the wireless medium 20 may be in the form of a PHY protocol data unit (“PPDU”). The PPDU may include a payload, i.e., the MAC frame or PDU, in conjunction with a delimiter of preamble and frame control information. A MAC Service Data Unit (MSDU) refers to any information that the MAC unit has been tasked to transport by upper protocol layers (e.g., OSI layers to which the OSI MAC layer provides services, e.g, DLL service user 42), along with any management information supplied by the MAC unit 24. A MAC PDU (MPDU) is provided by the MAC unit 24 to the PHY unit 26. In one embodiment, the MPDU may include a variable length body encapsulated by a MAC header and a Frame Check Sequence (FCS). The body may correspond to the MSDU and may include the header of the LLC PDU and a data frame (information or user data). As will be discussed hereinafter with reference to FIGS. 4 and 5, the MPDU may have the capacity to contain an entire MSDU or only a fragment of the MSDU.

With reference to FIGS. 4 and 5, the MAC unit 24 supports fragmentation. Fragmentation is a process of partitioning a MSDU or a MAC management protocol data unit (MMPDU) into smaller MPDUs. Fragmentation may improve the chances of frame delivery under poor channel conditions. Thus, an MSDU arriving at the MAC unit 24 may be placed in one or more MPDU fragments depending on the size of the MSDU. More specifically, when a MSDU is received from the LLC unit 22 or a MMPDU is received from the MAC sublayer management entity (not shown) with a length greater than the fragmentation threshold, the MSDU or MMPDU may be fragmented. The MPDUs resulting from the fragmentation of an MSDU or MMPDU are sent as independent transmissions, each of which is separately acknowledged. This permits transmission retries to occur per fragment, rather than per MSDU or MMPDU. FIG. 4 illustrates a fragmentation of an MSDU 44 so that it is partitioned into multiple MSDU portions 46 (illustrated by three portions MSDU #1, MSDU #2, and MSDU #3). The multiple MSDU portions 46 are encapsulated in multiple fragments 48 with the inclusion of a MAC header (HDR) and a cyclic redundancy code (CRC).

With reference to FIG. 5, an illustrative MAC unit 24 and PHY unit 26 are shown, which are configured to employ a fragmentation threshold. The MAC unit 24 may include a fragmentation module 50 and a control memory 52 that stores a value for fragmentation threshold (or fragment size) 54. The fragmentation module 50 may receive an MSDU from LLC unit 22 and then may partition the MSDU to produce multiple MPDU fragments if the MSDU size is greater than the fragmentation threshold 54. The MAC unit 24 may provide the MPDU fragments 56 to the PHY unit 26 for transmission. The PHY unit 26 may include a controller 58 and a transmit (TX)/receive (RX) unit or transceiver 60. In one embodiment, the transceiver 60 may operate according to the IEEE 802.11a, IEEE 802.11g, IEEE 802.11n or any other OFDM scheme and may perform such functions as forward error correcting code (FEC) encoding/decoding, modulation/demodulation, IFFT/FFT and so forth. In a transmit mode, the transceiver 60 may produces PPDUs from the MPDU fragments and transmit the PPDUs onto the medium via the DAC 30 and RF transceiver 34 in the form of OFDM symbols. In receive mode, the transceiver 60 may receive incoming OFDM symbols and may provide data frames from the OFDM symbols to the MAC unit 24. The controller 58 may control and may coordinate the activities of the transceiver 60, including providing the data rate to the transceiver 60. In addition, the controller 58 may adjust the fragmentation threshold 54. It will be appreciated that the functionality of the adjusting the threshold 54 need not reside in the PHY unit 26. This function could be performed in the MAC unit 24, the host device or elsewhere. In one embodiment, the fragmentation module 50 may be implemented in a transmit state machine and the threshold determination module 62 may be implemented by firmware executed by the controller 58 when the controller 58 is in the form of a processor. The fragmentation module 50 may access the control memory 52 to transfer the threshold value 54 to the fragmentation module 50 for its use. Fragmentation decisions may be static or dynamic according to the link characteristics.

As previously described in the Background section, the OFDM symbols at the network station 12 may transmit a “first number of bytes” per symbol, an integer number of bytes that is dependent upon the selected data rate. In one embodiment compatible with IEEE 802.11a, the selected data rate may be one of the eight different OFDM data rates ranging from 6 Mbps to 54 Mbps. The Number of Data Bits Per OFDM Symbol (Ndbps) of the second column of FIG. 3, when divided by eight, provides the “first number of bytes” per OFDM symbol for each of the data rates. Other embodiments may have different OFDM data rates. In one embodiment, the network station 12 may be positioned adjacent to a Bluetooth device generating Bluetooth interference or the network station 12 may have an Bluetooth device included therein that generates Bluetooth interference. A Dynamic Fragmentation Threshold (DFT) value, frequently expressed as an integer number of bytes, may be calculated by using any dynamic fragmentation threshold algorithm. The calculated DFT value will be referred to as the “second number of bytes”.

In order to co-exist with other wireless networks, e.g., Bluetooth, and obtain the best WLAN throughput, in one example the DFT value was calculated by a given dynamic fragmentation threshold algorithm to be 271 bytes and the transmit rate was chosen to be 54 Mbps. In order to transmit the 271 data bytes+24 bytes MAC header, the OFDM PHY unit 26 may use 12 OFDM symbols. More specifically, in addition to the 271 data bytes and the 24 bytes MAC header, there may be an additional 16 service bits and 6 tail bits that are transmitted as part of the data. Therefore, ((271+24)*8+16+6)/216=11.03 OFDM symbols. Since there is a fractional number of OFDM symbols, the number of OFDM symbols needed for transmission of a fragment having 271 data bytes is the next highest integer number of OFDM symbols, which is 12 OFDM symbols in this example. However, in the same number of symbols (in this case 12 OFDM symbols), another 26 bytes may be sent without changing the probability of interference with the Bluetooth device.

An Aligned Actual Fragment Threshold (AAFT) value may be calculated, which may have an “aligned number of bytes” that make use of the above-described unused bytes not used by the DFT value. Hence, the AAFT may be characterized as being “aligned” with the OFDM symbols. The AAFT calculation makes use of the knowledge of Ndbps shown in FIG. 3 in order to calculate the AAFT. In general, a “third number of bytes” may be determined, which represents additional bytes that may be transmitted without an increase in Bluetooth interference in this example. The third number of bytes may then be added to the second number of bytes of the DFT value to obtain the aligned number of bytes of the AAFT value. The aligned number of bytes of the AAFT approximately is a multiple of the first number of bytes of the OFDM symbol. Hence, in this example, the AAFT is set to 297 data bytes (aligned number of data bytes) instead of 271 data bytes (the second number of bytes), with the third number of data bytes being 297−271=26 bytes. With use of the AAFT, the number of symbols may be calculated as follows (need to also take into account service and tail bits): ((297+24)*8+16+6)/216≈12 OFDM symbols. Consequently, in this example, the transmit throughput may be increased by approximately 9.5%. In an OFDM scheme where the Ndbps per channel is doubled, then the throughput may be increased by approximately 19%.

In the above example, an initial fragmentation threshold was the DFT. In a more elaborate example, the initial fragmentation threshold may be an Actual Fragmentation Threshold (AFT) value calculated using the DFT. The AFT value may be calculated and used for the “second number of bytes” in the above-described calculation of the AAFT. The AFT calculation may be as follows:
AFT=max(256, min(DFT, dot11FragmentationThreshold))
The value “dot11FragmentationThreshold” is a IEEE 802.11 management information base (MIB) object and refers to the fragmentation threshold. It is an integer value of bytes and is specified to have a range of 256-2346 bytes, with a default value that is vendor specific. Frequently, the dot11FragmentationThreshold is set to the maximal value. The Dynamic Fragmentation Threshold (DFT) may be the outcome of any dynamic fragmentation threshold algorithm. The 256 is Wireless Fidelity (WiFi) limitation of the Wireless Ethernet Compatibility Alliance for a minimum fragment length. Hence, the AFT calculation may be bounded by these three parameters, with the “min” meaning to select the minimum value of the DFT and the dot11Fragmentation Threshold and the “max” meaning to select the maximum of 256 (WiFi specification) and the value of the minimum operation.

In one embodiment, the calculation of the AAFT by the controller 58, in accordance with one embodiment of the present invention, may be implemented as follows. First, a table holding Ndbps per data rate may be used, such as shown in FIG. 3. Next, an AAFT may be calculated as follows:
AAFT=floor((ceil(((AFT+MAC_Header_Size)*8+22)/Ndbps(rate))*Ndbps(rate)−22)/8)−MAC_Header_Size
Ceil(X) rounds the number X to the nearest integer towards infinity. Floor(X) rounds the number X to the nearest integer towards minus infinity. In one embodiment, the MAC_Header_Size may vary over a range starting with 24 bytes; the dot11FragmentationThreshold may be set for the data without the size of the MAC header; and the DFT also may be defined for the data, without the size of the MAC header. In one embodiment, a MAC header may include source and destination MAC addresses.

In one embodiment, the above-mentioned dynamic threshold algorithm for determining the DFT may be a Bluetooth (BT) coexistence algorithm which implements the following. If the BT device is transferring voice, then the data frames may be fragmented according to a current rate to be no longer then 620 uSec in duration. “BT device is transferring voice” is indicated by a special signal between a BT device (not shown) and the network station 12 (or the BT device may be integrated into the network station 12). The duration “620 uSec” may be the longest duration of packets in the air that does not damage the quality of the BT voice transmission. Bluetooth refers to a standard (Specification of the Bluetooth System, Version 1.1, Feb. 22, 2001) frequently used to build small networks between peripherals, a form of “wireless wires”. As will be discussed hereinafter, the BT coexistence algorithm is just one example of a dynamic fragmentation threshold algorithm which may be used with the network station 12.

The dynamic fragmentation threshold to be aligned may be generated for reasons other than the previously-described Bluetooth interference. For example, the dynamic fragmentation threshold may be generated based upon measured conditions of the wireless medium (“measured link quality”) as determined by received data frames from another network station. In one embodiment, the link quality (or link characteristics) may be measured by a signal-to-noise ratio (SNR) of the received data frames from the other network station. In another embodiment, the lack of ACKs from the other network station may be indicative of link quality. Other measurements of link quality may be used to establish a DFT.

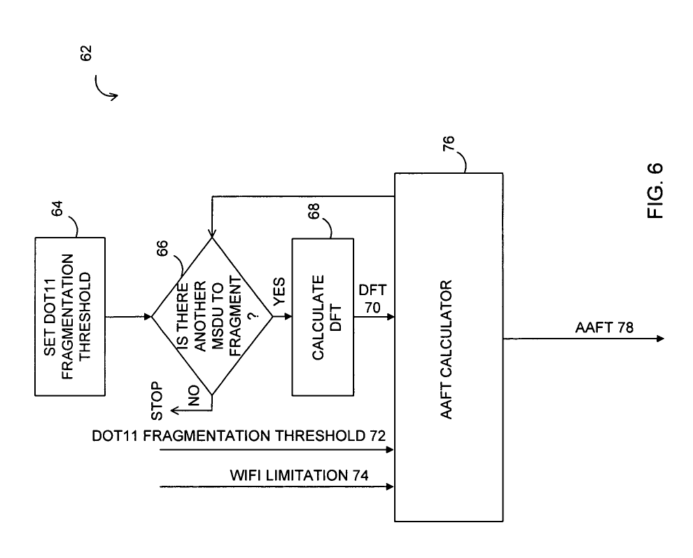

Referring to FIGS. 5 and 6, the controller 58 of the network station 12, in accordance with one embodiment of the present invention, may include a fragmentation threshold determination module 62 that may calculate the AAFT value and store it in the control memory 52 as the threshold value 54. The threshold determination module 62 may be implemented in the controller 58 using hardware or firmware. Additionally, it should be understood that this threshold determination function may be implemented in other locations, such as being part of the driver software for the network station 12 that is executed by a processor of the host device (e.g., data link layer service user 42 of FIG. 2) of the network station 12.

Referring to FIG. 6, the logic of the threshold determination module 62 for calculating the above-described AAFT is shown. At a stage 64, the dot11FragmentationThreshold value may be set. At a stage 66, there may be a determination as to whether there is another MSDU to fragment. In yes, the module 62 may proceed to a stage 68, where the above described DFT value is calculated. If no, the module 62 may stop until there are more frames to fragment. After calculating the DFT value 70, the above described AFT algorithm may be executed to obtain the actual threshold fragmentation (AFT) value. To execute the AFT algorithm, the DFT value 70, the dot11FragmentationThreshold value 72, and the WiFi limitation value 74 may first provided as inputs to a combined AFT and AAFT calculator (“AAFT calculator”) 76. Thereafter, the above-described AAFT algorithm may be used by the AAFT calculator 76 to obtain the aligned threshold fragmentation value (AAFT) value 78. After the calculation of the AAFT, the module 62 may return to the stage 66.

In this illustrative embodiment, the AAFT algorithm may determine the third number of bytes, which represents the additional number of bytes that may be transmitted by replacing the otherwise unused bytes with bytes of data. The third number of bytes is the number of bytes that may be added to the second number of bytes of the AFT value to obtain the “aligned number of bytes” of the AAFT.

The terminology used herein will now be generalized to cover a wide range of embodiments. The Actual Fragmentation Threshold (AFT) is just one example of an “initial fragmentation threshold”. The Aligned Actual Fragmentation Threshold (AAFT) is just one example of an “aligned fragmentation threshold”. The term “initial fragmentation threshold” shall refer to any fragmentation threshold which needs alignment to approximately include multiples of the first number of bytes of the OFDM symbol. Although not limited to dynamic fragmentation thresholds, the term “initial fragmentation threshold” may include one or more dynamic fragmentation thresholds generated by one or more dynamic fragmentation algorithms which need to be aligned with the OFDM symbols. Likewise, the term “aligned fragmentation threshold” shall mean the resulting fragmentation threshold achieved by aligning or adjusting the initial fragmentation threshold so that it includes approximately a multiple of the first number of bytes of the OFDM symbol. When referring to a “number of bytes”, a “number of bits” could also be used.

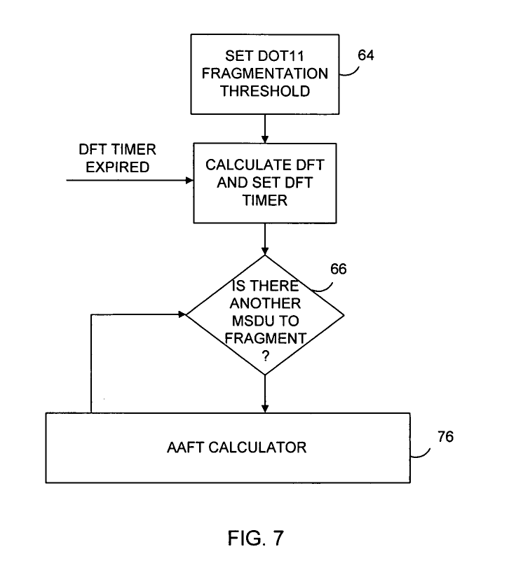

FIG. 7 shows the logic of a threshold determination module 80, in accordance with one embodiment of the present invention, which may include a modification to the threshold determination module 62 of FIG. 6. The stages 64 and 66 and the calculator 76 remain the same as in FIG. 6. A stage 82 calculates the DFT with the same dynamic fragmentation algorithm of FIG. 2, but the stage now is moved to the other side of the stage 66; hence, the DFT is not recalculated with each frame fragmentation. Moreover, a time for a DFT timer (not shown) may be calculated by the stage 82 with the expiration of the time being used to trigger calculation of the next DFT.

In summary, with reference to all the Figures, the network station 12, in accordance with one embodiment of the present invention, may be used to increase the throughput when fragmentation is used with OFDM. One illustrative reason for using fragmentation is because of environmental interference such as that caused by Bluetooth devices. The threshold determination module 62 of the network station 12 may take into consideration OFDM characteristics in order to choose an aligned fragmentation threshold which eliminates or reduces unused bytes when generating fragments. Conceptually, the module 62 provides a method for aligning the initial fragmentation threshold to the OFDM symbols to generate the aligned fragmentation threshold. The aligned fragmentation threshold may be calculated in such a way that the wireless transmission medium may be essentially fully utilized; hence, substantially no unused bytes may be transmitted. Therefore, the overall throughput may be increased by approximately 9.5% (by approximately 19% when the Ndbps per channel are doubled).

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. A method, comprising:
selecting an Orthogonal Frequency Division Multiplexing (OFDM) symbol at a network station to transmit a first number of bytes;
determining by the network station of an initial fragmentation threshold value having a second number of bytes;
increasing by the network station of the second number of bytes to generate an aligned fragmentation threshold value having an aligned number of bytes approximately equal to a multiple of the first number of bytes; and
fragmenting by the network station of a data frame into a plurality of fragments based on the aligned fragmentation threshold value.

2. The method of claim 1, wherein the determining of the initial fragmentation threshold value includes determining by the network station of a dynamic fragmentation threshold value.

3. The method of claim 2, wherein the determining of the dynamic fragmentation threshold value includes determining by the network station of a dynamic fragmentation threshold to reduce Bluetooth interference.

4. The method of claim 2, wherein the determining of the dynamic fragmentation threshold value includes determining by the network station of a dynamic fragmentation threshold based upon a measured communication link quality.

5. The method of claim 1, wherein the determining of the initial fragmentation threshold value includes computing by the network station an equation:
AFT=maximum(256, minimum(DFT, dot11FragmentationThreshold)),
wherein the AFT is the initial fragmentation threshold value, the 256 is a WiFi minimum threshold, the dot11FragmentationThreshold is an IEEE 802.11 defined fragmentation threshold value, and the DFT is a dynamic fragmentation threshold value.

6. The method of claim 1, wherein the increasing of the second number of bytes to generate the aligned fragmentation threshold value includes adding by the network station of a third number of bytes to the second number of bytes to make the aligned number of bytes substantially equal to the multiple of the first number of bytes.

7. An apparatus, comprising:
a transmitter to transmit a plurality of Orthogonal Frequency Division Multiplexing (OFDM) symbols, with each of the OFDM symbols having a first number of bytes;
a controller, coupled to the transmitter, to determine an initial fragmentation threshold value having a second number of bytes;
the controller being operable to increase the second number of bytes to generate an aligned fragmentation threshold value having an aligned number of bytes approximately equal to a multiple of the first number of bytes; and
a fragmentation module to fragment a data frame into a plurality of fragments in response to the aligned fragmentation threshold value.

8. The apparatus of claim 7, wherein the initial fragmentation threshold value is a dynamic fragmentation threshold value.

9. The apparatus of claim 7, wherein the initial fragmentation threshold value is a dynamic fragmentation threshold value to reduce Bluetooth interference.

10. The apparatus of claim 7, wherein the initial fragmentation threshold value is a dynamic fragmentation threshold value based upon a measured communication link quality.

11. The apparatus of claim 7, further comprising:
a control memory, coupled to the controller and the fragmentation module, to store the aligned fragmentation threshold value received from the controller; and wherein the fragmentation module is operable to obtain the aligned fragmentation threshold value from the control memory.

12. The apparatus of claim 11, further comprising:
a medium access control unit including the fragmentation module and the control memory.

13. The apparatus of claim 7, wherein the controller is operable to calculate a third number of bytes and to add the third number of bytes to the second number of bytes to make the aligned number of bytes approximately equal to the multiple of the first number of bytes.

14. The apparatus of claim 7, wherein the controller is operable to determine the initial fragmentation threshold by use of an equation:
AFT=maximum(256, minimum(DFT, dot11FragmentationThreshold)),
wherein the AFT is the initial fragmentation threshold value, the 256 is a WiFi minimum threshold, the dot11FragmentationThreshold is an IEEE 802.11 defined fragmentation threshold value; and the DFT is a dynamic fragmentation threshold value.

15. A system, comprising:
an antenna;
a physical medium interface unit coupled to the antenna, including
a transmitter to transmit a plurality of Orthogonal Frequency Division Multiplexing (OFDM) symbols, with each of the OFDM symbols having a first number of bytes,
a controller, coupled to the transmitter, to determine an initial fragmentation threshold value having a second number of bytes, and
the controller being operable to increase the second number of bytes to generate an aligned fragmentation threshold value having an aligned number of bytes approximately equal to a multiple of the first number of bytes; and
a media access control unit coupled to the physical medium interface unit, including
a fragmentation module to fragment a data frame into a plurality of fragments in response to the aligned fragmentation threshold value.

16. The system of claim 15, wherein the system is a network station selected from a group consisting of an access point and a client station.

17. The system of claim 15, wherein the initial fragmentation threshold value is a dynamic fragmentation threshold value.

18. The system of claim 15, wherein the initial fragmentation threshold value is a dynamic fragmentation threshold value to reduce Bluetooth interference.

19. The system of claim 15, wherein the initial fragmentation threshold value is a dynamic fragmentation threshold value based upon a measured communication link quality.

20. The system of claim 15, wherein the controller is operable to calculate a third number of bytes and to add the third number of bytes to the second number of bytes to make the aligned number of bytes approximately equal to the multiple of the first number of bytes.

21. The system of claim 15, wherein the antenna, the physical medium interface unit and the media access control unit form a first network station; the system further comprises a second network station to receive the plurality of OFDM symbols from the first station; and the first and second network stations are communicatively coupled to each other via a wireless medium.

22. An article comprising a storage medium; and a plurality of instructions stored in the storage medium designed to determine an aligned fragmentation threshold value to be used to fragment a data frame into a plurality of fragments, the plurality of instructions including
a rate selection routine to select an Orthogonal Frequency Division Multiplexing (OFDM) symbol to transmit a first number of bytes;
a fragmentation threshold routine to determine an initial fragmentation threshold value having a second number of bytes; and
the fragmentation threshold routine being designed to increase the second number of bytes to generate the aligned fragmentation threshold value with an aligned number of bytes approximately equal to a multiple of the first number of bytes.

23. The article of claim 22, wherein the initial fragmentation threshold value is a dynamic fragmentation threshold value.

24. The article of claim 23, wherein the dynamic fragmentation threshold value is a dynamic fragmentation threshold to reduce Bluetooth interference.

25. The article of claim 23, wherein the dynamic fragmentation threshold value is a dynamic fragmentation threshold based upon a measured communication link quality.
